(19) United States
(12) Patent Application Publication
(10) Pub. No.: US 2004/0098466 A1
(43) Pub. Date: May 20, 2004

(54) Method for reproducing contents information in interactive optical disc device and method for providing contents information in contents provider server

(75) Inventors: Woo Seong Yoon, Namyangloo-si (KR); Jea Yong Yoo, Seoul (KR); Tae Ho Kim, Seoul (KR); Limonov Alexandre, Seoul (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/713,580

(22) Filed: Nov. 12, 2003

(30) Foreign Application Priority Data
Nov. 16, 2002 (KR) 10-2002-71378

(51) Int. Cl. G06F 15/16

(52) U.S. Cl. 709/217

(57) ABSTRACT

Disclosed herein are a method for reproducing contents information in an interactive optical disc device and a method for providing contents information in a contents provider server. The interactive optical disc device is connected with the contents provider server via the Internet to receive a variety of contents information provided from the contents provider server. When the sending of the contents information from the contents provider server to the interactive optical disc device is suspended or delayed due to a network connection loss on the Internet or an insufficient storage capacity of a buffer memory in the interactive optical disc device, contents information re-sent from the contents provider server and a data stream read from an interactive DVD are re-synchronized and reproduced. Therefore, a user of the interactive optical disc device can normally watch more various contents information.

### BACKGROUND OF THE INVENTION

1. Field of the Invention

The present invention relates to a method for reproducing contents information in an interactive optical disc device and a method for providing contents information in a contents provider (CP) server, wherein a variety of contents information relevant to A/V data of an optical disc, such as an interactive digital versatile disc (I-DVD), is provided from the CP server over the Internet and then reproduced in the interactive optical disc device.

2. Description of the Related Art

Recently, high-density optical discs capable of storing mass digital data, for example, DVDs, have become widespread. These DVDs have been commercially available as large-capacity storage media capable of storing high-quality video data as well as digital audio data.

Such a DVD includes a navigation data recording area for recording navigation data necessary for control of reproduction of video data, and a data stream recording area for recording a digital data stream such as the video data.

Therefore, a general DVD player is adapted to, if the DVD is loaded therein, read the navigation data recorded in the navigation data recording area, store the read navigation data in a memory thereof, and then perform a DVD reproduction operation using the stored navigation data to read and reproduce the video data recorded in the data stream recording area.

As a result, a user of the DVD player can not only watch the high-quality video data recorded on the DVD, but also select and use a variety of functions provided from the DVD.

Meanwhile, a concrete scheme for an interactive digital versatile disc (I-DVD) capable of additionally recording detailed information relevant to A/V data to be reproduced therefrom, as various contents information such as an ‘html file’, and reproducing the recorded contents information through an interaction with a user is recently under discussion among the associated companies. If this I-DVD is commercially available, the user will be able to readily retrieve the various contents information relevant to the A/V data.

Under discussion is another scheme able to, while reproducing the A/V data and contents information recorded on the I-DVD, receive other various contents information from a contents provider server over the Internet and reproduce the received contents information synchronously with the A/V data being reproduced. In this scheme, however, the sending of the contents information from the contents provider server may be suspended or delayed due to a network connection loss or an insufficient storage capacity of a buffer memory in an interactive optical disc device. In this case, a re-synchronization must be performed with respect to the contents information and A/V data. However, there is currently no concrete scheme for the re-synchronization and there is thus an urgent need for the solution.

### SUMMARY OF THE INVENTION

Therefore, the present invention has been made in view of the above problems, and it is an object of the present invention to provide a method for reproducing contents information in an interactive optical disc device and a method for providing contents information in a contents provider server, wherein the interactive optical disc device is connected with the contents provider server via the Internet to receive a variety of contents information provided from the contents provider server and, if the sending of the contents information from the contents provider server to the interactive optical disc device is suspended or delayed, contents information re-sent from the contents provider server and a data stream read from an interactive DVD are re-synchronized and reproduced.

In accordance with one aspect of the present invention, the above and other objects can be accomplished by the provision of a method for producing contents information in an interactive optical disc device, comprising the steps of: a) synchronizing and reproducing data read from an interactive optical disc and contents information sent and downloaded from a contents provider server connected via the Internet; b) if the sending of said contents information from said contents provider server is suspended or delayed, generating a command for requesting re-sending of specific contents information, with reference to specific information contained in normally reproduced last contents information, and sending the generated command to said contents provider server; and c) reproducing said specific contents information re-sent from said contents provider server in response to said command together with data read from said interactive optical disc while re-synchronizing it with said data read from said interactive optical disc.

In accordance with another aspect of the present invention, there is provided a method for producing contents information in an interactive optical disc device, comprising the steps of: a) downloading and managing offset table information from a contents provider server connected via the Internet; b) synchronizing and reproducing contents information sent and downloaded from said contents provider server and data read from an interactive optical disc; c) if the sending of said contents information from said contents provider server is suspended or delayed, generating a command for requesting re-sending of specific contents information, with reference to said offset table information, and sending the generated command to said contents provider server; and d) reproducing said specific contents information re-sent from said contents provider server in response to said command together with data read from said interactive optical disc while re-synchronizing it with said data read from said interactive optical disc.

In accordance with another aspect of the present invention, there is provided a method for producing contents information in an interactive optical disc device, comprising the steps of: a) synchronizing and reproducing data read from an interactive optical disc and contents information sent and downloaded from a contents provider server connected via the Internet; and b) if a size of contents information downloaded into a buffer memory of said interactive optical disc device and not reproduced yet is smaller than or equal to a first predetermined reference value or greater than or equal to a second predetermined reference value, sending a command for requesting adjustment of a contents information bit rate to said contents provider server.

In accordance with another aspect of the present invention, there is provided a method for providing contents information in a contents provider server, comprising the steps of: a) sequentially sending data packets containing contents information whose sending is requested by an interactive optical disc device connected via the Internet, and specific information regarding said contents information whose sending is requested; b) if the sending of said requested contents information is suspended or delayed, receiving a command for requesting re-sending of specific contents information, from said interactive optical disc device; and c) re-sending a data packet containing said specific contents information and specific information regarding it to said interactive optical disc device in response to said command.

In accordance with another aspect of the present invention, there is provided a method for providing contents information in a contents provider server, comprising the steps of: a) sending offset table information regarding contents information whose sending is requested by an interactive optical disc device connected via the Internet; b) if the sending of said offset table information is completed, sequentially sending said contents information whose sending is requested by said interactive optical disc device; c) if the sending of said requested contents information is suspended or delayed, receiving a command for requesting re-sending of specific contents information, from said interactive optical disc device; and d) re-sending said specific contents information to said interactive optical disc device in response to said command.

In accordance with another aspect of the present invention, there is provided a method for providing contents information in a contents provider server, comprising the steps of: a) sequentially sending contents information whose sending is requested by an interactive optical disc device connected via the Internet; and b) if a command for requesting adjustment of a contents information bit rate is received from said interactive optical disc device, adjusting the bit rate in response to the received command and sending the requested contents information at the adjusted bit rate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing a connection between an interactive optical disc device and a contents provider server to which the present invention is applied;

FIG. 2 is a conceptual diagram illustrating a data reproduction operation of the interactive optical disc device to which the present invention is applied;

FIG. 3 is a flow chart illustrating a procedure of sending and receiving data between the interactive optical disc device and the contents provider server in accordance with a first embodiment of the present invention;

FIG. 4 is a flow chart illustrating a procedure of sending and receiving data between the interactive optical disc device and the contents provider server in accordance with a second embodiment of the present invention;

FIG. 5 is a flow chart illustrating a procedure of sending and receiving data between the interactive optical disc device and the contents provider server in accordance with a third embodiment of the present invention;

FIG. 6 is a flow chart illustrating a procedure of sending and receiving data between the interactive optical disc device and the contents provider server in accordance with a fourth embodiment of the present invention;

FIG. 7 is a view showing the configuration of a video/audio offset table in accordance with the present invention.

### DETAILED DESCRIPTION OF PREFFERRED EMBODIMENTS

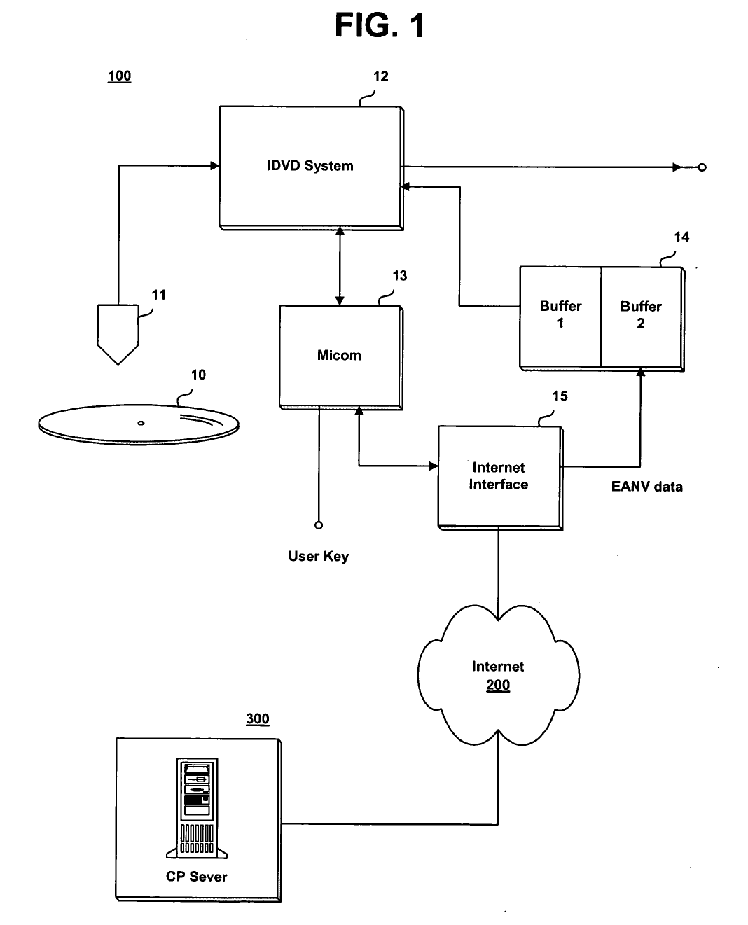

FIG. 1 shows a connection between an interactive optical disc device and a contents provider server to which the present invention is applied. As shown in this drawing, the interactive optical disc device, for example, an interactive DVD (I-DVD) player 100, comprises an optical pickup 11, I-DVD system 12, microcomputer 13, buffer memory 14 and Internet interface 15.

The I-DVD system 12 is adapted to synchronize and reproduce A/V data and contents information read from an I-DVD 10 and the Internet interface 15 is connected with the contents provider (CP) server, which is denoted by the reference numeral 300, via the Internet 200 by virtue of an interaction between the microcomputer 13 and an enhanced navigator (not shown) in the I-DVD system 12, as shown in FIG. 1.

The buffer memory 14 is adapted to download and temporarily store a variety of contents information, for example, a variety of ENAV (Enhanced Navigation) contents data such as audio data relevant to the video data read from the I-DVD 10, provided from the CP server 300. The buffer memory 14 can be logically divided into a first buffer Buffer 1 and a second buffer Buffer 2.

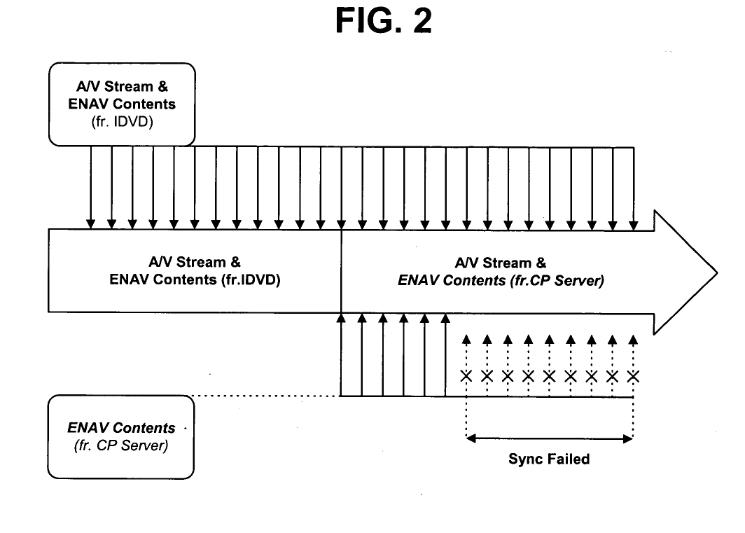

The enhanced navigator in the I-DVD system 12 functions to, while reproducing an A/V stream and ENAV contents information read from the I-DVD 10, reproduce other ENAV contents information provided from the CP server 300 synchronously with the A/V stream, as shown in FIG. 2.

Therefore, a user of the I-DVD player 100 can watch the ENAV contents information, for example, audio data, provided from the CP server 300 along with the A/V stream and/or ENAV contents information read from the I-DVD 10.

Meanwhile, the provision of the ENAV contents information from the CP server 300, such as the audio data, may be suspended or delayed due to a network connection loss on the Internet or an insufficient storage capacity of the buffer memory in the I-DVD player. In this case, the enhanced navigator in the I-DVD system 12 performs a series of operations to re-synchronize the data stream read from the I-DVD 10 and the audio data provided from the CP server 300, as will hereinafter be described in detail.

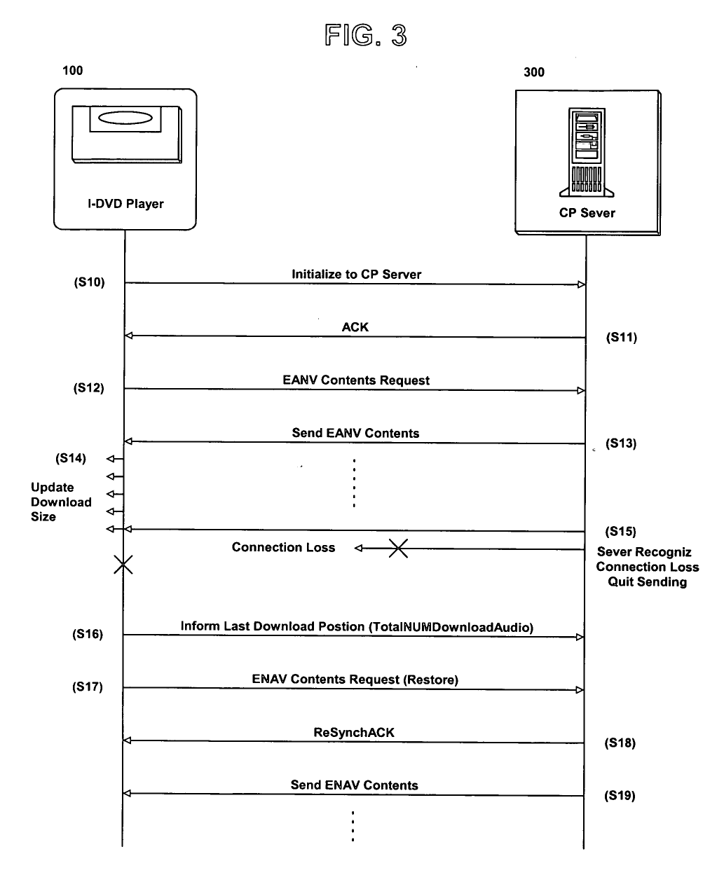

FIG. 3 is a flow chart illustrating a procedure of sending and receiving data between the interactive optical disc device and the contents provider server in accordance with a first embodiment of the present invention. For example, upon occurrence of an event based on a script or a user's request while reproducing an A/V stream from the I-DVD 10 loaded in the device as stated previously, the I-DVD player 100 initializes an Internet connection with the CP server 300 (S10), and the CP server 300 performs a corresponding operation (S11).

Thereafter, the I-DVD player 100 generates a command for requesting sending of ENAV contents information, such as audio data corresponding to the A/V stream being currently reproduced, and sends the generated command to the CP server 300 (S 12).

In response to the command from the I-DVD player 100, the CP server 300 retrieves the requested audio data from a database (not shown) and then sends it as ENAV contents information to the I-DVD player 100 (S 13). The I-DVD player 100 downloads and temporarily stores the audio data provided as the ENAV contents information from the CP server 300 into the buffer memory 14, and then reproduces the stored audio data together with video data read from the I-DVD 10 while synchronizing it with the video data.

Meanwhile, the I-DVD player 100 continuously updates the size of audio data, or ENAV contents information, downloaded into the buffer memory 14 (S 14). Also, the CP server 300 has an error processing function prepared against network connection losses, such as clients' access failures on the Internet and time-out, and listens to clients' accesses.

If a network connection loss occurs, the CP server 300 quits the sending of the ENAV contents information (S15). If the sending of the ENAV contents information is quitted, the I-DVD player 100 checks the last download position of the buffer memory 14, for example, information ‘TotalNumDownloadAudio’ indicative of an offset of the audio data downloaded from the CP server 300 and stored in the buffer memory 14, and then sends the checked result to the CP server 300 (S16).

Thereafter, the I-DVD player 100 generates a command for requesting re-sending of the ENAV contents information, for example, a command ‘Restore’ for requesting re-sending of ENAV contents information subsequent to the offset of the audio data downloaded into the buffer memory 14, and then sends the generated command to the CP server 300 (S17).

Meanwhile, the CP server 300 recognizes a recording position of audio data at a point of time that the ENAV contents information sending is quitted, with reference to the information ‘TotalNumDownloadAudio’ received through the above procedure, and, upon receiving the command ‘Restore’, sends a corresponding command ‘ReSynchACK’ to the I-DVD player 100 (S18), reads ENAV contents information at the recognized recoding position and re-sends the read ENAV contents information to the I-DVD player 100 (S19). The I-DVD player 100 recognizes only ENAV contents information just after the command ‘ReSynchACK’ sending, as normal data, so it can establish an accurate re-synchronization between data read from the I-DVD 10 and the contents information. This series of operations S15-S19 are repeated each time a network connection loss occurs.

Therefore, even in the case where the sending of ENAV contents information from the CP server is suspended or delayed due to a network connection loss on the Internet or an insufficient storage capacity of the buffer memory in the I-DVD player, the ENAV contents information can be normally re-sent/received through an interaction between the I-DVD player and the CP server as stated above, so that it can be normally reproduced along with data read from the I-DVD while being re-synchronized with the read data.

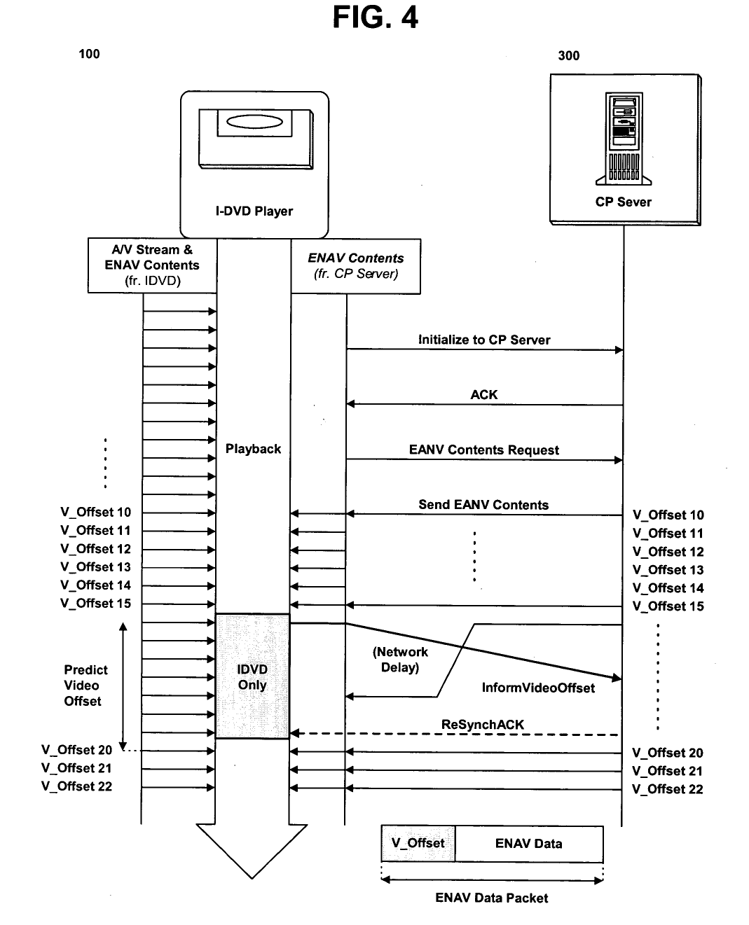

FIG. 4 is a flow chart illustrating a procedure of sending and receiving data between the interactive optical disc device and the contents provider server in accordance with a second embodiment of the present invention. As stated previously, the I-DVD player 100 initializes an Internet connection with the CP server 300, and the CP server 300 performs a corresponding operation.

Thereafter, the I-DVD player 100 generates a command for requesting sending of ENAV contents information, such as audio data corresponding to an A/V stream being currently reproduced, and outputs the generated command to the CP server 300.

In response to the command from the I-DVD player 100, the CP server 300 retrieves the requested audio data from a database and then sends it as ENAV contents information to the I-DVD player 100. At this time, the audio data is sent as the ENAV contents information in the form of an ENAV data packet composed of video offset information V_Offset and ENAV data ENAV Data, as shown in FIG. 4.

The I-DVD player 100 then synchronizes and reproduces the A/V stream read from the I-DVD 10 and the ENAV contents information, or audio data, downloaded from the CP server 300 and temporarily stored in the buffer memory 14 with reference to the video offset information V_Offset in the ENAV data packet.

On the other hand, when the sending of the audio data over the Internet is suspended or delayed due to a network connection loss on the Internet as stated above, or when the size of audio data temporarily stored in the buffer memory 14 and not reproduced yet is zero or below a predetermined reference value, the I-DVD player 100 calculates a re-synchronizable predictive video offset value with reference to a bandwidth of a network bit rate.

For example, where a normally received video offset value is ‘V_Offset 15’ and the synchronizable predictive video offset value is ‘V_Offset 20’, the I-DVD player 100 generates a command for requesting sending of audio data corresponding to the offset value ‘V_Offset 20’, for example, a command ‘InformVideoOffset’, and then sends the generated command to the CP server 300.

In response to the command ‘InformVideoOffset’, the CP server 300 seeks a recording position of the audio data corresponding to the offset value ‘V_Offset 20’, reads the audio data at the sought recording position and sends it to the I-DVD player 100. At this time, the audio data is sent in the form of an ENAV data packet with video offset information indicative of the offset value ‘V_Offset 20’.

Therefore, the I-DVD player 100 checks the video offset information in the ENAV data packet received through the above procedure, and re-synchronizes and reproduces the audio data of the ENAV data packet and the data read from the I-DVD 10 if the video offset value is equal to an offset value of the video data being currently read and reproduced from the I-DVD 10.

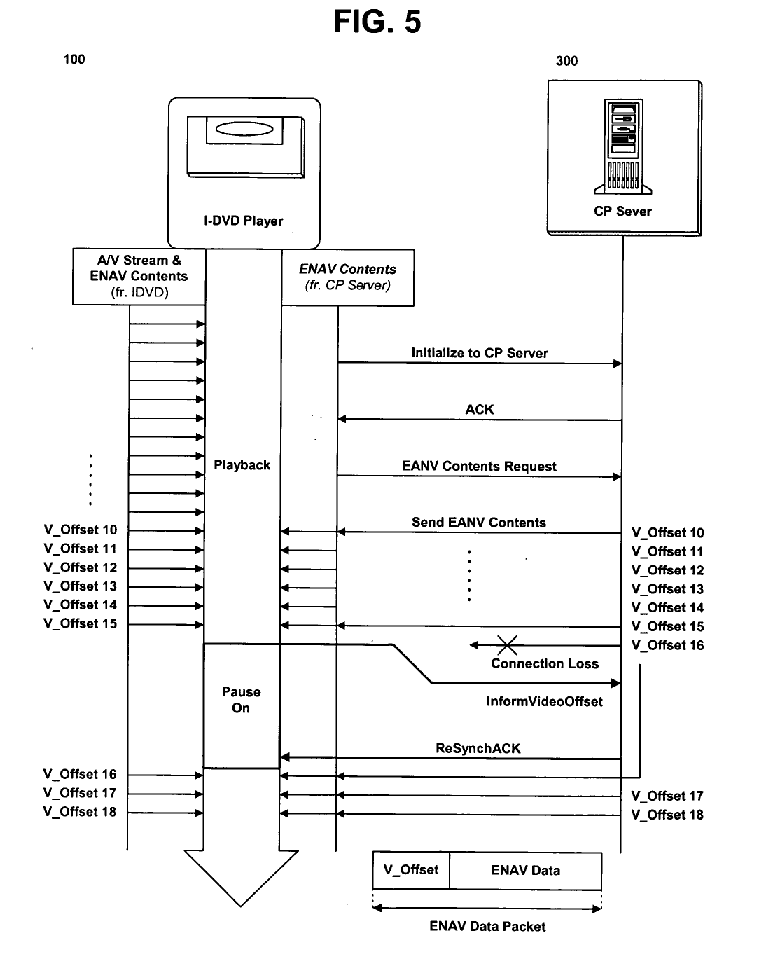

FIG. 5 is a flow chart illustrating a procedure of sending and receiving data between the interactive optical disc device and the contents provider server in accordance with a third embodiment of the present invention. As stated previously, the I-DVD player 100 initializes an Internet connection with the CP server 300, and the CP server 300 performs a corresponding operation.

Thereafter, the I-DVD player 100 generates a command for requesting sending of ENAV contents information, such as audio data corresponding to an A/V stream being currently reproduced, and outputs the generated command to the CP server 300.

In response to the command from the I-DVD player 100, the CP server 300 retrieves the requested audio data from a database and then sends it as ENAV contents information to the I-DVD player 100. At this time, the audio data is sent as the ENAV contents information in the form of an ENAV data packet composed of video offset information V_Offset and ENAV data ENAV Data, as shown in FIG. 5.

The I-DVD player 100 then synchronizes and reproduces the A/V stream read from the I-DVD 10 and the ENAV contents information, or audio data, downloaded from the CP server 300 and temporarily stored in the buffer memory 14 with reference to the video offset information V_Offset in the ENAV data packet.

On the other hand, when the sending of the audio data over the Internet is suspended or delayed due to a network connection loss on the Internet as stated above, or when the size of audio data temporarily stored in the buffer memory 14 and not reproduced yet is zero or below a predetermined reference value, the I-DVD player 100 automatically changes the current play mode to a Pause On mode.

The I-DVD player 100 then checks a normally received video offset value. For example, where the normally received video offset value is ‘V_Offset 15’, the I-DVD player 100 generates a command for requesting sending of audio data corresponding to the next video offset value, ‘V_Offset 16’, for example, a command ‘InformVideoOffset’, and then sends the generated command to the CP server 300.

Meanwhile, in response to the command ‘InformVideoOffset’, the CP server 300 seeks a recording position of the audio data corresponding to the offset value ‘V_Offset 16’, reads the audio data at the sought recording position and sends it to the I-DVD player 100. At this time, the CP server 300 first sends a command for notifying re-sending of the contents information, for example, a command ‘ReSynchACK’, and then sends an ENAV data packet of the audio data containing the offset value ‘V_Offset 16’.

The I-DVD player 100 checks the video offset information in the ENAV data packet received through the above procedure after the command ‘ReSynchACK’ is received, and automatically changes the Pause On mode to a Pause Off mode if the video offset value is the video offset value ‘V_Offset 16’ of the requested audio data.

Further, if the video offset value is equal to an offset value of the video data read from the I-DVD 10, the I-DVD player 100 re-synchronizes and reproduces the audio data of the ENAV data packet and the data read from the I-DVD 10.

For reference, the video offset information, sent while being contained in the ENAV data packet, may be replaced with playback time information or audio offset information. In this case, with reference to the playback time information or audio offset information instead of the video offset information, the I-DVD player and the CP server send/receive corresponding ENAV data.

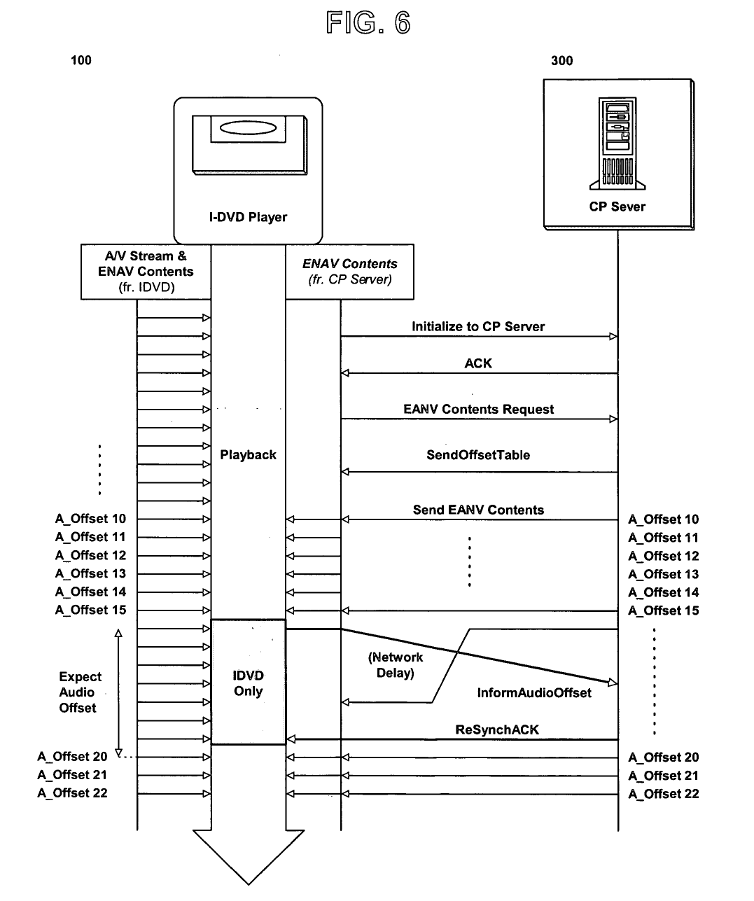

FIG. 6 is a flow chart illustrating a procedure of sending and receiving data between the interactive optical disc device and the contents provider server in accordance with a fourth embodiment of the present invention. As stated previously, the I-DVD player 100 initializes an Internet connection with the CP server 300, and the CP server 300 performs a corresponding operation.

Thereafter, the I-DVD player 100 generates a command for requesting sending of ENAV contents information, such as audio data corresponding to an A/V stream being currently reproduced, and outputs the generated command to the CP server 300.

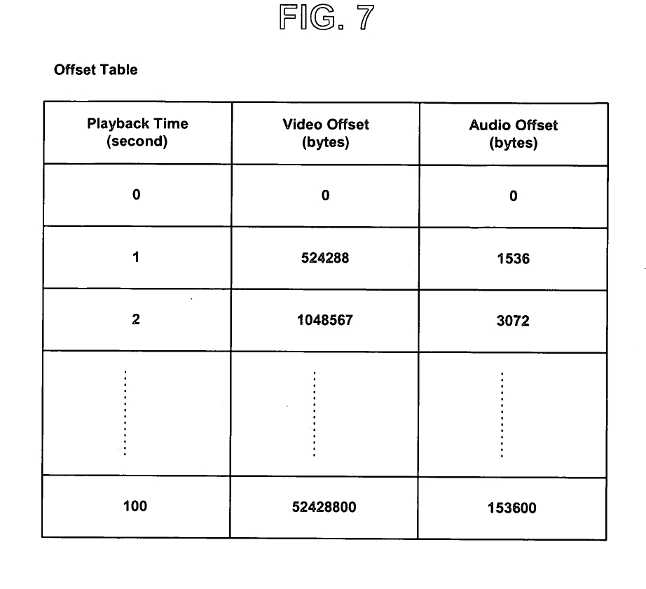

Meanwhile, the CP server 300 sends information about an offset table to the I-DVD player 100, which stores, for example, playback time information, video offset information and audio offset information in a linked manner, as shown in FIG. 7.

Also, in response to the command from the I-DVD player 100, the CP server 300 retrieves the requested audio data from a database and then sends it as ENAV contents information to the I-DVD player 100. The I-DVD player 100 synchronizes and reproduces the A/V stream read from the I-DVD 10 and the ENAV contents information, or audio data, downloaded from the CP server 300 and temporarily stored in the buffer memory 14.

On the other hand, when the sending of the audio data over the Internet is suspended or delayed due to a network connection loss on the Internet as stated above, or when the size of audio data temporarily stored in the buffer memory 14 and not reproduced yet is zero or below a predetermined reference value, the I-DVD player 100 calculates a re-synchronizable predictive audio offset value with reference to a bandwidth of a network bit rate.

The I-DVD player 100 also checks an audio offset value corresponding to normally received audio data with reference to the offset table information previously sent from the CP server 300. For example, in the case where the audio offset value corresponding to the normally received audio data is ‘A_Offset 15’ and the synchronizable predictive audio offset value is ‘A_Offset 20’, the I-DVD player 100 generates a command for requesting sending of audio data corresponding to the offset value ‘A_Offset 20’, for example, a command ‘InformAudioOffset’, and then sends the generated command to the CP server 300.

In response to the command ‘InformAudioOffset’, the CP server 300 seeks a recording position of the audio data corresponding to the offset value ‘A_Offset 20’ with reference to the offset table information, reads the audio data at the sought recording position and sends it to the I-DVD player 100. At this time, the CP server 300 first sends a command for notifying re-sending of the contents information, for example, a command ‘ReSynchACK’, and then sends the audio data corresponding to the offset value ‘A_Offset 20’.

Therefore, after receiving the command ‘ReSynchACK’, the I-DVD player 100 reproduces the audio data sent through the above procedure while re-synchronizing it with the data being currently read from the I-DVD 10.

For reference, with reference to playback time information or video offset information instead of the audio offset information, the I-DVD player and the CP server may send/receive corresponding ENAV data.

Also, the I-DVD player 100 may send information regarding a storage capacity of the ENAV contents information, for example, audio data, downloaded into the buffer memory 14 to the CP server 300, and the CP server 300 may check the audio data storage capacity and variably control a bit rate of audio data being sent to the I-DVD player appropriately according to the checked result.

For example, in the process of initializing the Internet connection between the CP server 300 and the I-DVD player 100, the CP server 300 allocates and sends an Internet protocol (IP) address and port number necessary for the connection to the I-DVD player 100, and the I-DVD player 100 checks the current available buffer size of the buffer memory 14 and sends the resulting information to the CP server 300.

The CP server 300 controls a bit rate of audio data being sent to the I-DVD player 100 appropriately with reference to the buffer size information from the I-DVD player 100 so as to prevent a buffer under-run or overflow of audio data to be stored in the buffer memory.

For reference, the IP address and port number may be sent in the form of a command ‘ConnToCtrlServer(char *IP, cha *port)’, and the buffer size information may be sent in the form of a command ‘SendUsableBuffer’.

Further, in the case where the I-DVD player 100 changes the play mode to the Pause On mode in response to the user's request, it generates a command ‘SendPauseOn’ for notification of the Pause On mode and sends it to the CP server 300. In the case of changing the Pause On mode to the Pause Off mode, it generates a command ‘SendPauseOff’ for notification of the Pause Off mode and sends it to the CP server 300.

Therefore, the CP server suspends or resumes the sending of audio data according to the operation mode of the I-DVD player.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. For example, the present invention is applicable to rewritable DVDs, such as a DVD-RW and DVD-RAM, or various information storage media, as well as the I-DVD.

As apparent from the above description, the present invention provides a method for reproducing contents information in an interactive optical disc device and a method for providing contents information in a contents provider server, wherein the interactive optical disc device is connected with the contents provider server via the Internet to receive a variety of contents information provided from the contents provider server and, even if the sending of the contents information from the contents provider server to the interactive optical disc device is suspended or delayed, contents information re-sent from the contents provider server and a data stream read from an interactive DVD are re-synchronized and reproduced, so that a user of the interactive optical disc device can normally watch more various contents information.

What is claimed is:

1. A method for reproducing contents information in an interactive optical disc device, comprising the steps of:
a) synchronizing and reproducing data read from an interactive optical disc and contents information sent and downloaded from a contents provider server connected via the Internet;
b) if the sending of said contents information from said contents provider server is suspended or delayed, generating a command for requesting re-sending of specific contents information, with reference to specific information contained in normally reproduced last contents information, and sending the generated command to said contents provider server; and
c) reproducing said specific contents information re-sent from said contents provider server in response to said command together with data read from said interactive optical disc while re-synchronizing it with said data read from said interactive optical disc.

2. The method as set forth in claim 1, wherein said specific information contained in said normally reproduced last contents information includes at least one of playback time information, contents information offset information, and offset information of said data read from said interactive optical disc.

3. The method as set forth in claim 2, wherein said step b) includes the steps of:
b-1) checking said specific information contained in said normally reproduced last contents information if the sending of said contents information from said contents provider server is suspended or delayed;
b-2) calculating information regarding re-synchronizable contents information based upon said checked specific information; and
b-3) generating a command for requesting re-sending of specific contents information corresponding to the calculated information regarding said re-synchronizable contents information and sending the generated command to said contents provider server.

4. The method as set forth in claim 3, wherein said information regarding said re-synchronizable contents information is calculated with reference to a bandwidth of a current network bit rate.

5. The method as set forth in claim 3, wherein said command for requesting the re-sending of said specific contents information includes a parameter, said parameter being said information regarding said re-synchronizable contents information.

6. The method as set forth in claim 3, wherein said step c) includes the steps of:
c-1) extracting said specific information from said specific contents information re-sent from said contents provider server; and
c-2) re-synchronizing and reproducing said data read from said interactive optical disc and said re-sent specific contents information based upon the extracted specific information.

7. The method as set forth in claim 6, wherein said step c) further includes the step of receiving a command for notification of the re-sending of said specific contents information from said contents provider server before said step c-1) is performed.

8. The method as set forth in claim 2, wherein said step b) includes the steps of:
b-1) if the sending of said contents information from said contents provider server is suspended or delayed, determining whether a size of contents information downloaded into a buffer memory of said interactive optical disc device and not reproduced yet is below a predetermined reference value;
b-2) automatically pausing a data reproducing operation of said interactive optical disc if the size of said contents information downloaded into said buffer memory and not reproduced yet is below said predetermined reference value; and
b-3) generating said command for requesting the re-sending of said specific contents information, with reference to said specific information contained in said normally reproduced last contents information, and sending the generated command to said contents provider server.

9. The method as set forth in claim 8, wherein said step b-3) includes the steps of:
b-3-1) checking said specific information contained in said normally reproduced last contents information;
b-3-2) calculating information regarding contents information subsequent to said normally reproduced last contents information based upon the checked specific information; and
b-3-3) generating a command for requesting re-sending of specific contents information corresponding to the calculated information and sending the generated command to said contents provider server.

10. The method as set forth in claim 9, wherein said command for requesting the re-sending of said specific contents information includes a parameter, said parameter being said information regarding said contents information subsequent to said normally reproduced last contents information.

11. The method as set forth in claim 8, wherein said step c) includes the steps of:
c-1) receiving a command for notification of the re-sending of said specific contents information from said contents provider server;
c-2) after said re-sending notification command is received, extracting said specific information from said specific contents information re-sent from said contents provider server; and
c-3) re-synchronizing and reproducing said data read from said interactive optical disc and said re-sent specific contents information based upon the extracted specific information.

12. A method for providing contents information in a contents provider server, comprising the steps of:
a) sequentially sending data packets containing contents information whose sending is requested by an interactive optical disc device connected via the Internet, and specific information regarding said contents information whose sending is requested;
b) if the sending of said requested contents information is suspended or delayed, receiving a command for requesting re-sending of specific contents information, from said interactive optical disc device; and
c) re-sending a data packet containing said specific contents information and specific information regarding it to said interactive optical disc device in response to said command.

13. The method as set forth in claim 12, wherein said sent contents information is audio data to be reproduced synchronously with video data read from an interactive optical disc in said interactive optical disc device.

14. The method as set forth in claim 12, wherein said specific information includes at least one of playback time information, contents information offset information, and offset information of data read from an interactive optical disc.

15. The method as set forth in claim 12, wherein said command for requesting the re-sending of said specific contents information includes a parameter, said parameter being information regarding said specific contents information.

16. The method as set forth in claim 15, wherein said step c) includes the steps of:
c-1) seeking a position of data corresponding to said information regarding said specific contents information;
c-2) sending a command for notification of the re-sending of said specific contents information to said interactive optical disc device; and
c-3) reading said specific contents information at said position and re-sending said data packet containing said specific contents information and said specific information regarding it to said interactive optical disc device.

17. A method for reproducing contents information in an interactive optical disc device, comprising the steps of:
a) downloading and managing offset table information from a contents provider server connected via the Internet;
b) synchronizing and reproducing contents information sent and downloaded from said contents provider server and data read from an interactive optical disc;
c) if the sending of said contents information from said contents provider server is suspended or delayed, generating a command for requesting re-sending of specific contents information, with reference to said offset table information, and sending the generated command to said contents provider server; and
d) reproducing said specific contents information re-sent from said contents provider server in response to said command together with data read from said interactive optical disc while re-synchronizing it with said data read from said interactive optical disc.

18. The method as set forth in claim 17, wherein said offset table information includes playback time information, offset information of said data read from said interactive optical disc and contents information offset information in a linked manner.

19. The method as set forth in claim 17, wherein said step c) includes the steps of:
c-1) extracting information regarding normally reproduced last contents information from said offset table information if the sending of said contents information from said contents provider server is suspended or delayed;
c-2) calculating information regarding re-synchronizable contents information based upon the extracted information; and
c-3) generating a command for requesting re-sending of specific contents information corresponding to the calculated information regarding said re-synchronizable contents information and sending the generated command to said contents provider server.

20. The method as set forth in claim 19, wherein said information regarding said re-synchronizable contents information is calculated with reference to a bandwidth of a current network bit rate.

21. The method as set forth in claim 19, wherein said command for requesting the re-sending of said specific contents information includes a parameter, said parameter being said information regarding said re-synchronizable contents information.

22. The method as set forth in claim 17, wherein said step d) includes the steps of:
d-1) receiving a command for notification of the re-sending of said specific contents information from said contents provider server; and
d-2) after said re-sending notification command is received, reproducing said specific contents information re-sent from said contents provider server together with said data read from said interactive optical disc while re-synchronizing it with said data read from said interactive optical disc.

23. The method as set forth in claim 17, wherein said contents information sent from said contents provider server is audio data, and said data read from said interactive optical disc includes video data.

24. The method as set forth in claim 1, wherein said contents information sent from said contents provider server is audio data, and said data read from said interactive optical disc includes video data.

25. A method for providing contents information in a contents provider server, comprising the steps of:
a) sending offset table information regarding contents information whose sending is requested by an interactive optical disc device connected via the Internet;
b) if the sending of said offset table information is completed, sequentially sending said contents information whose sending is requested by said interactive optical disc device;
c) if the sending of said requested contents information is suspended or delayed, receiving a command for requesting re-sending of specific contents information, from said interactive optical disc device; and
d) re-sending said specific contents information to said interactive optical disc device in response to said command.

26. The method as set forth in claim 25, wherein said sent contents information is audio data to be reproduced synchronously with video data read from an interactive optical disc in said interactive optical disc device.

27. The method as set forth in claim 25, wherein said offset table information includes playback time information, offset information of data read from an interactive optical disc and contents information offset information in a linked manner.

28. The method as set forth in claim 25, wherein said command for requesting the re-sending of said specific contents information includes a parameter, said parameter being information regarding said specific contents information.

29. The method as set forth in claim 28, wherein said step d) includes the steps of:
d-1) seeking a position of data corresponding to said information regarding said specific contents information;
d-2) sending a command for notification of the re-sending of said specific contents information to said interactive optical disc device; and
d-3) reading said specific contents information at said position and re-sending it to said interactive optical disc device.

30. A method for reproducing contents information in an interactive optical disc device, comprising the steps of:
a) synchronizing and reproducing data read from an interactive optical disc and contents information sent and downloaded from a contents provider server connected via the Internet; and
b) if a size of contents information downloaded into a buffer memory of said interactive optical disc device and not reproduced yet is smaller than or equal to a first predetermined reference value or greater than or equal to a second predetermined reference value, sending a command for requesting adjustment of a contents information bit rate to said contents provider server.

31. The method as set forth in claim 30, wherein said step a) includes the steps of:
a-1) over said Internet, attempting a connection to said contents provider server having said contents information to be reproduced synchronously with said data read from said interactive optical disc;
a-2) generating a command for requesting sending of said contents information, based upon information necessary for the connection sent from said contents provider server, and sending the generated command to said contents provider server; and
a-3) synchronizing and reproducing said contents information sent and downloaded from said contents provider server in response to said sending request command and said data read from said interactive optical disc.

32. The method as set forth in claim 31, wherein said information necessary for the connection sent from said contents provider server includes an Internet protocol (IP) address and port number of said contents provider server.

33. The method as set forth in claim 30, wherein said command for requesting the adjustment of said contents information bit rate includes a parameter, said parameter being an available memory size of said buffer memory.

34. A method for providing contents information in a contents provider server, comprising the steps of:
a) sequentially sending contents information whose sending is requested by an interactive optical disc device connected via the Internet; and
b) if a command for requesting adjustment of a contents information bit rate is received from said interactive optical disc device, adjusting the bit rate in response to the received command and sending the requested contents information at the adjusted bit rate.

35. The method as set forth in claim 34, wherein said step a) includes the steps of:
a-1) if a connection from said interactive optical disc device is attempted over said Internet, sending information necessary for the connection to said interactive optical disc device; and
a-2) if a command for requesting sending said contents information is received from said interactive optical disc device, sequentially sending said contents information whose sending is requested by said interactive optical disc device.

36. The method as set forth in claim 35, wherein said information necessary for the connection includes an IP address and port number of said contents provider server.

37. The method as set forth in claim 34, wherein said command for requesting the adjustment of said contents information bit rate includes a parameter, said parameter being an available memory size of a buffer memory of said interactive optical disc device.

38. The method as set forth in claim 37, wherein said step b) includes the steps of:
b-1) if said command for requesting the adjustment of said contents information bit rate is received from said interactive optical disc device, calculating a new bit rate in consideration of said parameter of said command, a current bit rate and a play speed of said contents information; and
b-2) sending said contents information at the calculated bit rate.
